(19) United States
(12) Patent Application Publication
(10) Pub. No.: US 2025/0135472 A1
(43) Pub. Date: May 1, 2025

(54) SHOWERHEAD ASSEMBLY

(71) Applicant: ASSA ABLOY Americas Residential Inc., New Haven, CT (US)

(72) Inventor: Paulo Pajuelo, Lake Forest, CA (US)

(73) Assignee: ASSA ABLOY Americas Residential Inc., New Haven, CT (US)

(21) Appl. No.: 18/923,899

(22) Filed: Oct. 23, 2024

Related U.S. Application Data
(60) Provisional application No. 63/593,009, filed on Oct. 25, 2023.

(51) Int. Cl. B05B 1/18; B05B 1/16; B05B 15/62

(52) U.S. Cl. CPC B05B 1/18; B05B 1/16; B05B 15/62

(57) ABSTRACT

A showerhead assembly includes a handheld showerhead and a docking support. A magnetic connection removably mounts the handheld showerhead to the docking support. Magnets are mounted within a rear face of the handheld showerhead and magnets are mounted behind a mounting face of the docking support. Both the rear face of the handheld showerhead and the mounting face are substantially smooth surfaces. Additionally, the mounting face includes a pair of shoulders that capture an interface of a head and a handle of the handheld showerhead thereby restricting rotation of the handheld showerhead when connected to the docking support.

### CROSS-REFERENCE TO RELATED APPLICATION(S)

This application claims the benefit of priority of U.S. Provisional Application No. 63/593,009, filed Oct. 25, 2023, the entire disclosure of which is incorporated herein by reference in its entirety.

### BACKGROUND

Some known showerhead assemblies include a handheld showerhead. The handheld showerhead can be used while docked, and for example, docked on a wall or a shower arm, or can be used while held in hand. A flexible hose extends between the dock and the handheld showerhead so that water flows into the handheld showerhead and so that the handheld showerhead can move relative to the dock when undocked. Because of the different use configurations of the handheld showerhead, it is desirable to have a connection mechanism between the handheld showerhead and dock that is both easy to attach and detach the handheld showerhead, as well as securely retain the handheld showerhead to the dock when attached. For at least these reasons, improvements are desired.

### SUMMARY

The present disclosure relates generally to water dispensing systems and showerhead assemblies and, more particularly, to removably mounting a handheld showerhead to a docking support.

The showerhead assemblies described herein magnetically couple the handheld showerhead to the docking support such that the handheld showerhead can be used in either a docked configuration while mounted on the docking support or an undocked configuration and remote from the docking support. The handheld showerhead includes one or more magnets disposed underneath a rear face of a head. The exterior surface of the head does not include any projections or recesses for ease of use. The docking support also includes one or more magnets disposed underneath a mounting face. The mounting face has a top portion that houses the magnets and a bottom portion that forms a pair of shoulders. When the handheld showerhead is mounted on the mounting face, the shoulders capture an interface between the head and a handle of the handheld showerhead to restrict rotation of the handheld showerhead.

In an aspect, the technology relates to a showerhead assembly including: a handheld showerhead including: a head with a front face including one or more outlet nozzles and an opposite rear face, the rear face having a substantially smooth surface, wherein one or more first magnets are disposed within the head and underneath the rear face; and a handle extending from the head; a docking support including: a housing defining an inlet and an outlet, the inlet configured to couple to a water supply, the housing defining a mounting face, the mounting face having a top portion and an opposite bottom portion, the mounting face elongated in a direction between the top portion and the bottom portion; one or more second magnets disposed within the housing and underneath the mounting face; and at least one rigid shoulder projecting from the bottom portion of the mounting face, wherein the rear face of the handheld showerhead removably mounts to the mounting face of the housing via a magnetic connection between the one or more first magnets and the one or more second magnets, and wherein when the handheld showerhead is mounted to the docking support, the at least one rigid shoulder at least partially captures a portion of the handle proximate the head to restrict rotation of the handheld showerhead relative to the docking support; and a hose coupled between the handle of the handheld showerhead and the outlet of the housing such that the handheld showerhead and the docking support are in fluid communication.

In an example, the mounting face has a substantially smooth surface. In another example, the mounting face has a vertical height between the top portion and the bottom portion and a transverse width orthogonal to the vertical height, the vertical height greater than the transverse width, and the vertical height is more than half of a height of the head of the handheld showerhead. In yet another example, the vertical height is at least 75% of the height of the head of the handheld showerhead. In still another example, the transverse width is less than a width of the head of the handheld showerhead. In an example, the handle has a thickness, the at least one rigid shoulder projecting less than half of the thickness of the handle.

In another example, the at least one rigid shoulder has curved upper and lower boundaries. In yet another example, the at least one rigid shoulder does not prevent pulldown of the handheld showerhead from the docking support. In still another example, the one or more first magnets are off-center in the head. In an example, the docking support further includes one or more second outlet nozzles.

In another aspect, the technology relates to a showerhead assembly including: a handheld showerhead including: a housing body defining a head and a handle extending from the head, the housing body having an exterior surface, wherein the exterior surface of a rear of the head has a convex curvature and is devoid of any projecting or recessed structure; one or more outlet nozzles supported by the housing body at a front of the head; and a pair of first magnets disposed within the housing body at the rear of the head, the pair of first magnets aligned with an extension direction of the handle; a docking support including: a housing defining an inlet and an outlet, the inlet configured to couple to a water supply, the housing having a front face including a mounting face, the mounting face having a substantially smooth surface that corresponds in shape to the exterior surface of the rear of the head of the housing body, the mounting face including a pair of lower shoulders that correspond in shape to an intersection of the handle at the head; a pair of second magnets disposed within the housing and underneath the mounting face, the pair of second magnets offset from the pair of lower shoulders, wherein the head of the housing body removably mounts to the mounting face of the housing via a magnetic connection between the pair of first magnets and the pair of second magnets, and wherein when the handheld showerhead is mounted to the docking support, the pair of lower shoulders at least partially captures the intersection of the handle at the head; and a hose coupled between the handle of the handheld showerhead and the outlet of the housing such that the handheld showerhead and the docking support are in fluid communication.

In an example, the pair of lower shoulders restrict rotation of the handheld showerhead and allow the handheld showerhead to be pulled downward relative to the docking support. In another example, the mounting face is elongated in a vertical direction, the mounting face having a height that is less than a height of the head of the housing body. In yet another example, the mounting face is the entire front face of the housing. In still another example, the docking support includes one or more second outlet nozzles supported at the front face of the housing.

In another aspect, the technology relates to a showerhead assembly including: a docking support including: a housing defining an inlet and an outlet, the inlet configured to couple to a water supply, the housing including a mounting face having a first portion and an adjacent second portion, the mounting face elongated in a direction between the first portion and the second portion, the first portion having a substantially smooth concave exterior surface; and one or more first magnets mounted below the exterior surface of the first portion; a handheld showerhead including: a head with a front face defining one or more outlet nozzles and an opposite rear face, wherein one or more second magnets are disposed within the head and underneath the rear face; and a handle extending from the head; an anti-rotation coupling including a pair of rounded shoulders; and a hose coupled between the handle of the handheld showerhead and the outlet of the housing such that the handheld showerhead and the docking support are in fluid communication, wherein the handheld showerhead removably mounts to the docking support via a magnetic connection between the rear face of the handheld showerhead and the first portion of the mounting face, wherein the pair of rounded shoulders are configured to extend between at least a portion of the handheld showerhead and the second portion of the mounting face to restrict rotation of the handheld showerhead relative to the docking support, and wherein the pair of rounded shoulders allow the handheld showerhead to be pulled downwards to detach the handheld showerhead from the docking support.

In an example, the pair of rounded shoulders are integrated within the second portion of the mounting, and the pair of rounded shoulders are rigid and directly contact an intersection of the handle and the head of the handheld showerhead when the handheld showerhead is mounted to the docking support. In another example, at least a portion of the mounting face includes an exterior rubber layer. In yet another example, the substantially smooth concave exterior surface of the first portion extends within the second portion of the mounting face. In still another example, the docking support includes a plurality of outlet nozzles spaced apart from the mounting face.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of an exemplary showerhead assembly in accordance with the principles of the present disclosure.

FIG. 2 is a rear perspective view of a handheld showerhead of the showerhead assembly shown in FIG. 1.

FIG. 3 is a rear exploded perspective view of the handheld showerhead.

FIG. 4 is a front exploded perspective view of the handheld showerhead.

FIG. 5 is a front perspective view of a docking support of the showerhead assembly shown in FIG. 1.

FIG. 6 is a front view of the docking support.

FIG. 7 is a front exploded perspective view of the docking support.

FIG. 8 is side view of the showerhead assembly of FIG. 1.

FIG. 9 is a cross-sectional view of the showerhead assembly of FIG. 1.

FIG. 10 in an enlarged cross-section view of a connection interface between the handheld showerhead and the docking support.

FIG. 11 is a perspective view of another showerhead assembly in accordance with the principles of the present disclosure.

FIG. 12 is a front perspective view of a docking support of the showerhead assembly shown in FIG. 11.

FIG. 13 is a front view of the docking support.

FIG. 14 is a front exploded perspective view of the docking support.

FIG. 15 is a side view of the showerhead assembly of FIG. 11.

FIG. 16 is a cross-sectional view of the showerhead assembly of FIG. 11.

FIGS. 17 and 18 are schematic views of exemplary mounting faces for a docking support.

The exemplifications set out herein illustrate embodiments of the invention, and such exemplifications are not to be construed as limiting the scope of the invention in any manner.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is appreciated that features of some examples may be combined with or removed from features in other examples.

The showerhead assemblies disclosed herein provide a magnetic mount for a handheld showerhead without any external structures added to the handheld showerhead. Magnets are disposed underneath a rear face of a head of the handheld showerhead. The rear face of the head retains a typical convex smooth shape. A docking support is configured to attach to a water source and includes a mounting face with magnets disposed therein. The mounting face has a corresponding concave smooth shape in order to match the rear face of the handheld showerhead. A top portion of the mounting face supports the magnets, while a bottom portion of the mounting face includes a pair of rigid shoulders. The shoulders are configured to capture at least a portion of the intersection of the head and a handle of the handheld showerhead and restrict rotation of the handheld showerhead when mounted to the docking support. In order to disconnect the handheld showerhead from the docking support, the magnetic coupling is overcome and the handheld showerhead can either be pulled outwards or downwards from the mounting face. The shoulders do not prevent the handheld showerhead from being pulled downwards.

In some examples, the docking support can include its own nozzle assembly for showering. The mounting face is spaced apart from the nozzle assembly on the docking support so that the handheld showerhead can be used with the nozzle assembly.

Many components of the showerhead assembly may be referred to as having generally cylindrically, circular, annular, or conical features, and as having cylindrical or circular holes, cavities, and openings. Such features may be referred to, or defined by, a circumference, radius, external surface, internal surface, and/or other terms appropriate for defining such features. It should be noted that such features may alternatively be elliptical, polygonal, and the like. As used herein, the terms “axial” and “longitudinal” refer to directions and orientations, which extend substantially parallel to a centerline of the showerhead assembly. Moreover, the terms “radial” and “radially” refer to directions and orientations, which extend substantially perpendicular to the centerline of the showerhead assembly. In addition, as used herein, the terms “circumferential” and “circumferentially” refer to directions and orientations, which extend arcuately about the centerline of the showerhead assembly.

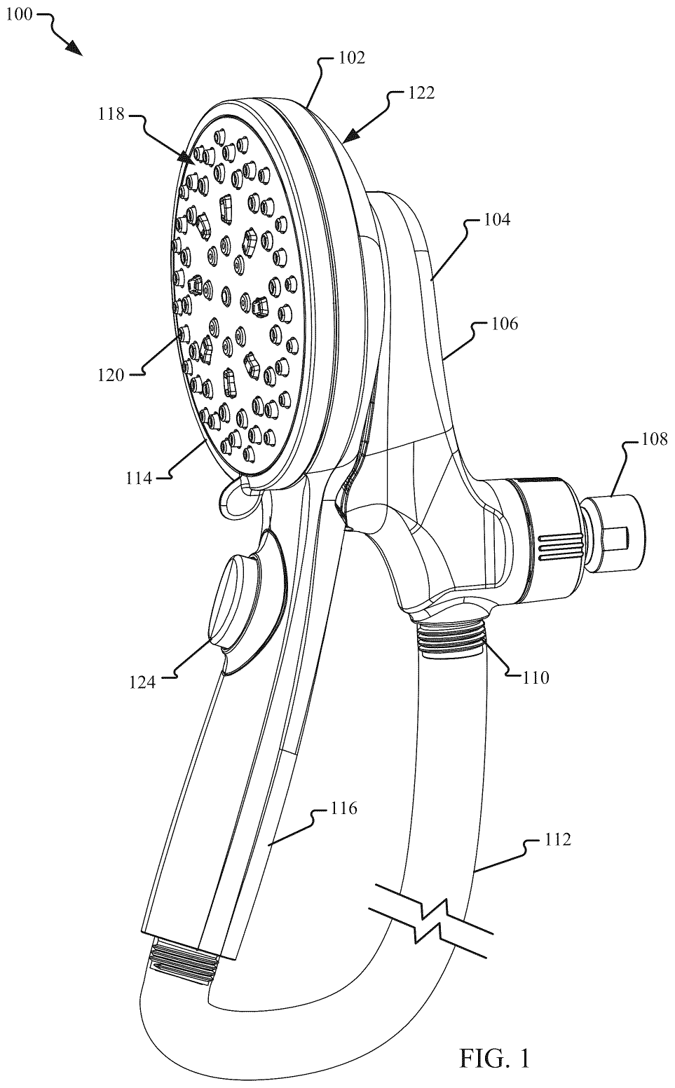

FIG. 1 is a perspective view of an exemplary showerhead assembly 100. The showerhead assembly 100 includes a handheld showerhead 102 and a docking support 104. The docking support 104 includes a housing 106 defining an inlet 108 and an outlet 110. The inlet 108 is configured to couple to a water source (e.g., a shower arm or the like) so that a flow of water is received and flows though the docking support 104. The handheld showerhead 102 is configured to removably mount to the docking support 104 via a magnetic connection. Accordingly, in a docked configuration (shown in FIG. 1), the handheld showerhead 102 is secured to the docking support 104 so that a user may shower without needing to hold the handheld showerhead 102. In an undocked configuration, the handheld showerhead 102 is removed from the docking support 104 and is manually moved remotely relative to the docking support 104 as required or desired. A hose 112 (shown schematically) is coupled between the handheld showerhead 102 and the outlet 110 of the docking support 104 so that the handheld showerhead 102 and the docking support 104 are coupled in fluid communication.

The handheld showerhead 102 includes a head 114 with a handle 116 extending therefrom. In the example, the head 114 is a substantially circular shaped head, however, other shapes (e.g., square) are also contemplated herein. The head 114 includes a front face 118 that defines one or more outlet nozzles 120. The outlet nozzles 120 discharge a flow of water from the handheld showerhead 102. The head 114 also includes an opposite rear face 122 that is configured to mount to the docking support 104. By using the rear face 122 to couple to the docking support 104, when the handheld showerhead 102 is in the docked configuration, the handheld showerhead 102 may still be used for showering. The handle 116 can include an actuator 124 that controls the flow of water through the outlet nozzles 120.

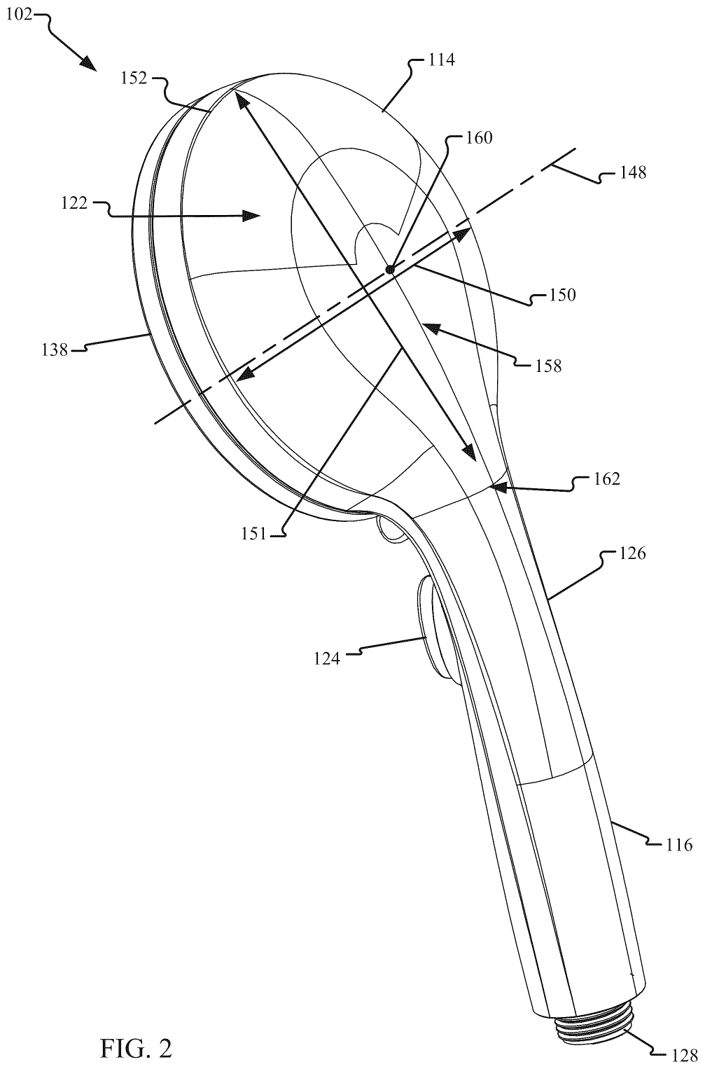

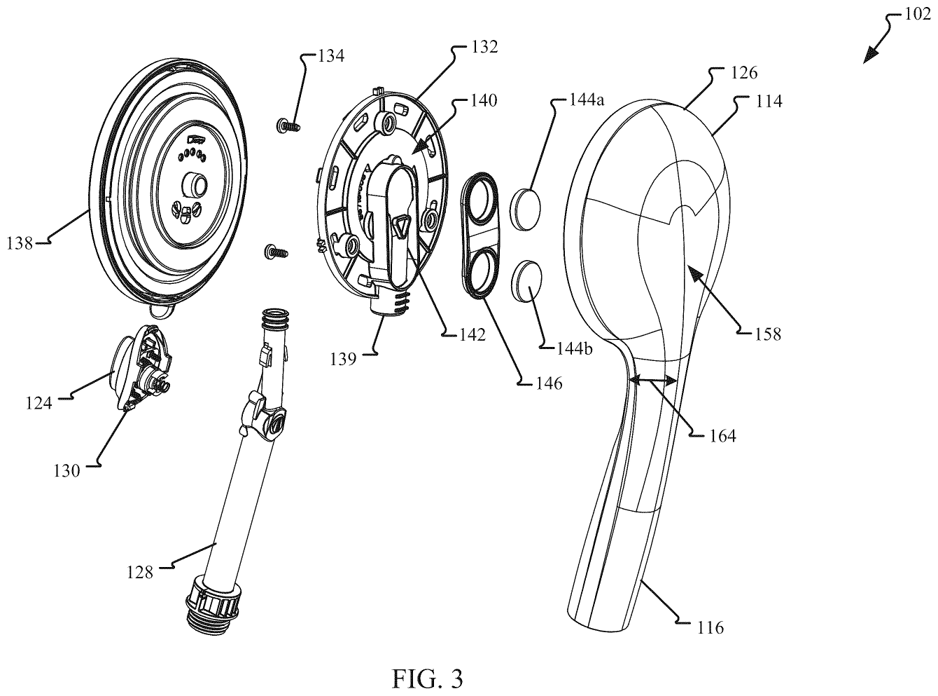

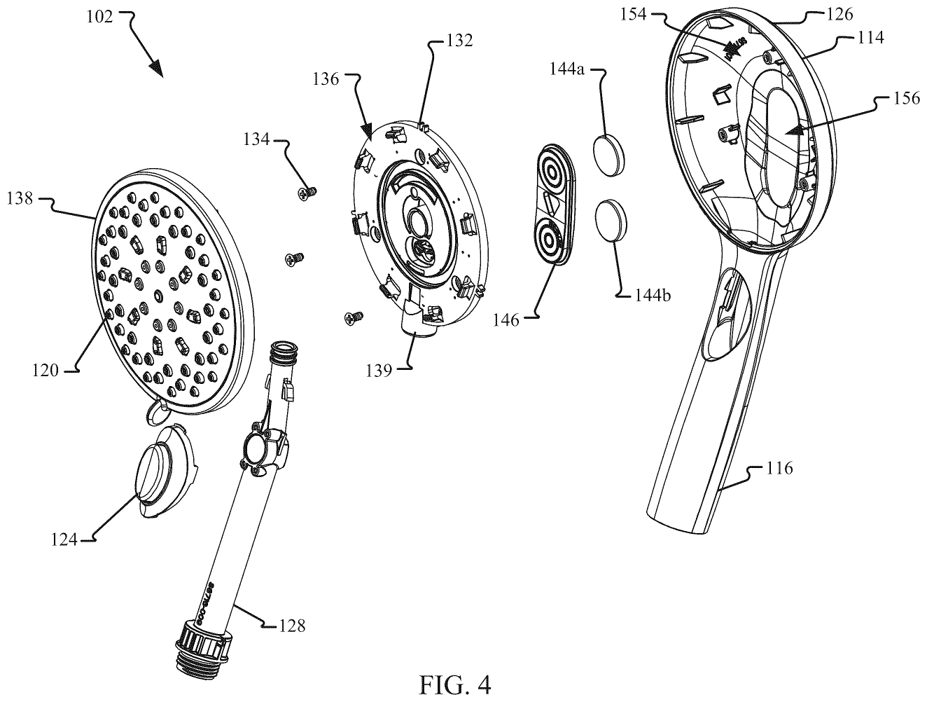

FIG. 2 is a rear perspective view of the handheld showerhead 102. FIGS. 3 and 4 are rear and front exploded perspective views of the handheld showerhead 102. Referring concurrently to FIGS. 2-4, the handheld showerhead 102 includes a housing body 126 that defines the head 114 and the handle 116. The housing body 126 supports a handle tube assembly 128 within the handle 116 and that is configured to couple to the hose 112 (shown in FIG. 1) and selectively allow water to flow through the handheld showerhead 102. The actuator 124 (e.g., a button) is a part of an actuator assembly 130 that operationally couples to the handle tube assembly 128 so as to control the flow of water therein. The actuator assembly 130 mounts to the handle 116 such that the actuator 124 is accessible to the user.

A manifold plate 132 is disposed within the head 114 and secured within the housing body 126 with fasteners 134. A front side 136 of the manifold plate 132 is coupled to a nozzle plate assembly 138 that includes the outlet nozzles 120. The manifold plate 132 is also coupled in flow communication with the handle tube assembly 128 at an inlet receiver 139. A flow of water is configured to be channeled through the manifold plate 132 towards the front side 136 and discharged through the nozzle plate assembly 138 at the outlet nozzles 120. The manifold plate 132 also includes a rear side 140 that faces an inner surface of the housing body 126. The rear side 140 includes a holder 142 configured to support a pair of magnets 144. In the example, the magnets 144 may be further retained within a gasket 146 that is supported in the holder 142.

The holder 142 is formed as a recessed channel and is elongated in a vertical direction (e.g., the direction that the handle 116 extends). The holder 142 is positioned mostly within a bottom section of the manifold plate 132. This configuration positions the magnets 144 off-center within the head 114 and mostly within a bottom section of the head 114. In the example, the head 114 defines a horizontal centerline plane 148 that bisects the head 114 at its greatest width 150 (e.g., the equator of the head 114 as the head 114 is substantially circular in shape). The magnets 144 are disposed at the horizontal centerline plane 148 or below so that a top 152 of the head 114 can be positioned higher within the shower and when the handheld showerhead 102 is mounted to the docking support 104 (shown in FIG. 1). In other aspect, the magnets 144 may be centered with respect to the horizontal centerline plane 148 or substantially above so as to position the head 114 lower on the docking support 104 as required or desired. A top magnet 144a may positioned to extend across the horizontal centerline plane 148, while a bottom magnet 144b may be entirely below the horizontal centerline plane 148. In other aspects, both magnets 144 may be disposed entirely below the horizontal centerline plane 148. The head 114 also has a vertical height 151 that is orthogonal to the width 150. The height 151 may be equal to the width 150 as the head 114 is circular in shape.

The housing body 126 has an inner surface 154 that at least the manifold plate 132 and the handle tube assembly 128 are configured mount within. At the head 114, the inner surface 154 defines a recess 156 that is substantially planar. The recess 156 is configured to receive the magnets 144 so that the magnets 144 are disposed directly adjacent to the wall of the housing body 126. The gasket 146 may provide a watertight seal around the magnets 144. While two magnets 144a,b are shown and described. In other examples, a single magnet or three or more magnets may be utilized as required or desired. In aspects, the magnet(s) may include anti-rotation features (e.g., magnet polarity location) to facilitate reducing or restriction rotation of the handheld showerhead 102 when mounted. By locating the magnets 144 between the manifold plate 132 and the housing body 126, assembly efficiencies of the handheld showerhead 102 are provided.

Additionally, the housing body 126 has an outer (e.g., exterior) surface 158. The outer surface 158 at the handle 116 is a substantially smooth surface and cylindrical in shape to facilitate a user holding the handheld showerhead 102 in the hand. The outer surface 158 at the head 114 forms the rear face 122 and is also a substantially smooth surface. The outer surface 158 at the rear face 122 does not have and is devoid of any projections, tabs, recesses, detents, or the like structural features that are typically used to couple the handheld showerhead 102 to the docking support 104. Rather, the handheld showerhead 102 only includes magnets 144 within the housing body 126 that facilitate coupling the handheld showerhead 102 to the docking support 104. In the example, the outer surface 158 at the rear face 122 has at least some convex curvature such that a midpoint 160 on the horizontal centerline plane 148 is the apex of the rear face 122 with curvature extending outwards and downwards towards an outer perimeter of the rear face 122. The magnets 144 are disposed within the head 114 and underneath the rear face 122. In the example, the outer surface 158 of the housing body 126 at the magnets 144 has a curvature, while the inner surface 154 at the recess 156 is planar. In an aspect, the outer surface 158 of the housing body 126 at the rear face 122 is not a planar surface.

The outer surface 158 of the housing body 126 also defines an intersection 162 where the handle 116 radially extends from the outer perimeter of the head 114. The curvature of the outer surface 158 smoothly transitions from the head 114 to the handle 116, and as such, the intersection 162 is formed with a concave curvature on the left and right sides, while the rear face 122 maintains its convex curvature at its centerline between the left and right sides when transitioning with the handle 116. The intersection 162 has a thickness 164 defined in the direction between the front face 118 and the rear face 122 of the handheld showerhead 102.

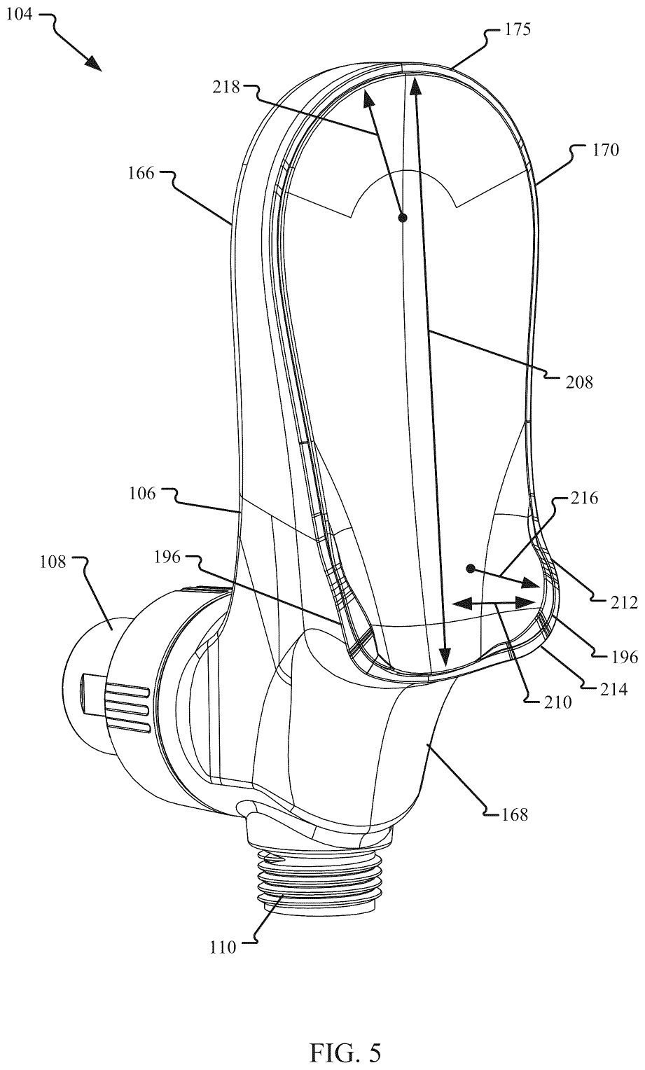

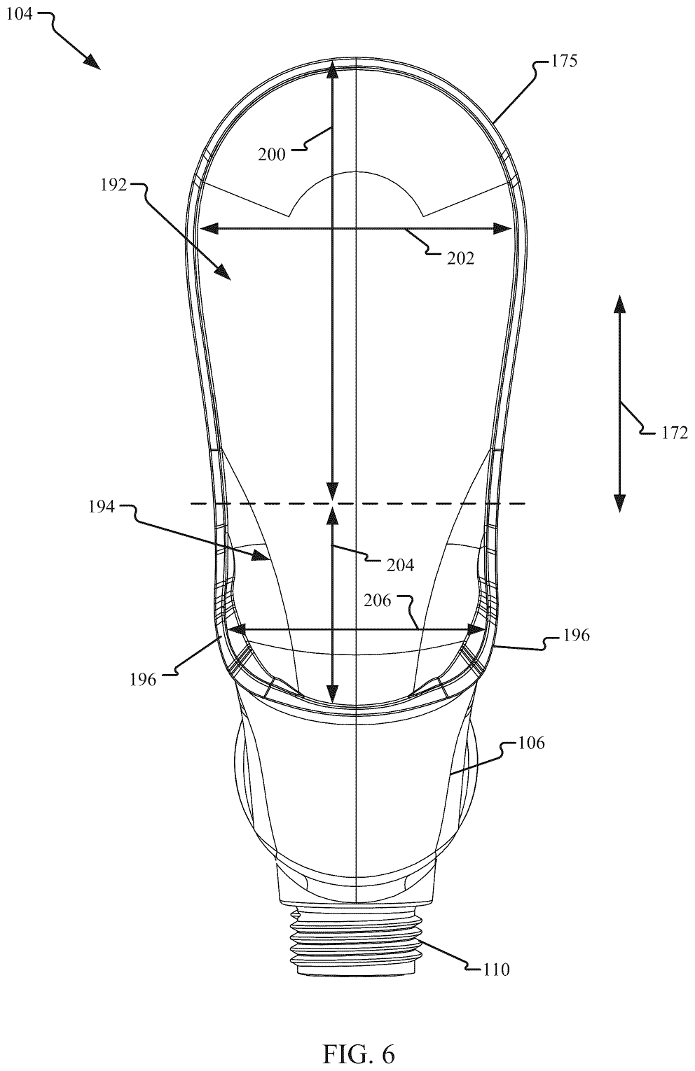

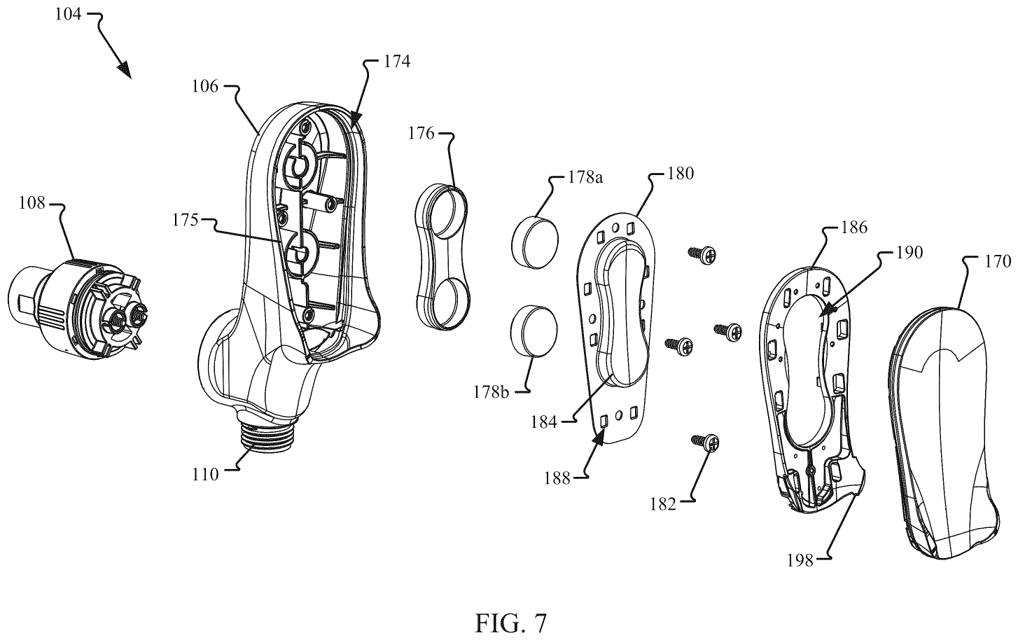

FIG. 5 is a front perspective view of the docking support 104. FIG. 6 is a front view of the docking support 104. FIG. 7 is a front exploded perspective view of the docking support 104. Referring concurrently to FIGS. 5-7, the docking support 104 includes the housing 106 defining the inlet 108 and the outlet 110. The inlet 108 is formed as a ball joint that couples to the housing 106. The inlet 108 couples to a water supply, such as a shower arm, and allows the housing 106 to be adjustably positioned relative to the inlet 108 via the ball joint. In some examples, the inlet 108 may include a quick connect assembly, such as the features described in WO2022/198060, published Sep. 22, 2022, and which is incorporated by reference herein in its entirety.

The housing 106 includes an upper portion 166 and an opposite lower portion 168. The lower portion 168 includes the inlet 108 and outlet 110, and thus, defines a flow channel through the housing 106. The upper portion 166 is fluidly sealed from the lower portion 168 and is configured to support a mounting face 170 that is used to couple the handheld showerhead 102 (shown in FIGS. 2-4) to the docking support 104. By positioning the mounting face 170 above the inlet 108 and outlet 110, the handheld showerhead 102 is positioned higher in the shower when mounted to the docking support 104. The upper portion 166 is elongated in a vertical direction 172 and includes a front face 174 that receives the mounting face 170. In the example, a perimeter flange 175 surrounds the front face 174.

The docking support 104 includes a discrete holder 176 that couples within the front face 174 of the housing 106. In an example, the holder 176 may be a snap-fit, press-fit, or the like. The holder 176 supports a pair of magnets 178 with a top magnet 178a and a bottom magnet 178b aligned along the vertical direction 172. The holder 176 may have discrete recesses for each magnet 178. A cover plate 180 secures the magnets 178 within the holder 176 and within the front face 174 of the housing 106 via one or more fasteners 182. In the example, the cover plate 180 includes a center pocket 184 that is shaped and sized to receive at least a portion of the holder 176 and seal the magnets 178 therein. A support plate 186 couples to the cover plate 180 at apertures 188 via a snap fit connection. The support plate 186 has an opening 190 so that the center pocket 184 extends at least partially through the support plate 186 and the support plate 186 does not cover the magnets 178. The mounting face 170 couples to the support plate 186 and covers the magnets 178 and so that the magnets 178 are positioned underneath the mounting face 170. In an aspect, the center pocket 184 may be disposed between the magnets 178 and the mounting face 170. By locating the magnets 178 within the cover plate 180 and adjacent the mounting face 170, assembly efficiencies of the docking support 104 are provided.

The mounting face 170 forms the forward most component of the docking support 104 and is configured to receive the handheld showerhead 102. The mounting face 170 includes a top portion 192 and a bottom portion 194 elongated in the vertical direction 172. The top portion 192 has the magnets 178 disposed underneath the mounting face 170. The bottom portion 194 does not have the magnets 178 disposed underneath the mounting face 170. The bottom portion 194 includes a pair of shoulders 196 projecting therefrom. The pair of shoulders 196 are shaped and sized to at least partially receive the intersection 162 between the head 114 and the handle 116 of the handheld showerhead 102 (shown in FIG. 2) and form an anti-rotation coupling between the docking support 104 and the handheld showerhead 102. In the example, the shoulders 196 have an outer perimeter that is rounded. The shoulders 196 may be defined at least partially by the flange 175 of the housing 106, projections 198 of the support plate 186, and the mounting face 170 such that the shoulders 196 are substantially rigid.

The top portion 192 has a height 200 and a width 202 that defines a surface area. The bottom portion 194 also has a height 204 and a width 206 that defines a surface area. The height 200 of the top portion 192 is greater than the height 204 of the bottom portion 194. The width 202 of the top portion 192 is greater than the width 206 of the bottom portion 194. As such, the surface area of the top portion 192 is greater than the surface area of the bottom portion 194. The shoulders 196 are disposed above the inlet 108 in the vertical direction 172. The magnets 178 being in the top portion 192 are such that the magnets 178 are vertically offset from the shoulders 196.

In an aspect, the height 204 of the bottom portion 194 is about two-thirds of the height 200 of the top portion 192. In an aspect, the width of the 206 of the bottom portion 194 is at least 90% of the width 202 of the top portion 192. In an aspect, the surface area of the bottom portion 194 is less than half of the surface area of the top portion 192.

A total vertical height 208 of the mounting face 170 is the sum of the heights 200, 204. The vertical height 208 of the mounting face 170 is greater than the maximum width 206 of the mounting face 170. The vertical height 208 of the mounting face 170 is also more than half of the vertical height 151 of the head 114 (shown in FIG. 2) of the handheld showerhead 102. In and aspect, the vertical height 208 of the mounting face 170 is at least 75% of the height 151 of the head 114. The width 206 of the mounting face 170 is less than the width 150 of the head 114 (shown in FIG. 2). In an aspect, the width 206 of the mounting face 170 is less than half of the width 150 of the head 114.

The mounting face 170 is a substantially smooth exterior surface for receiving the handheld showerhead 102. In an aspect, the mounting face 170 is the entire front face of the housing 106 of the docking support 104. The mounting face 170 corresponds in shape to the outer surface 158 of the housing body 126 (shown in FIGS. 2 and 3). The top portion 192 of the mounting face 170 does not have and is devoid of any projections, tabs, recesses, detents, or the like structural features. The bottom portion 194 of the mounting face 170 only has the shoulders 196. In the example, the exterior surface of the mounting face 170 smoothly transitions between the top and bottom portions 192, 194 and without any break. In an aspect, the exterior surface of the mounting face 170 is not a planar surface. The mounting face 170 is concave in shape so as to correspond to the rear face 122 of the head 114. In an aspect, the concave shape extends between the top portion 192 and the bottom portion 194. In an aspect, the exterior surface of the mounting face 170 may include a friction promoting surface, such as but not limited to, rubber and the like, so that the handheld showerhead 102 is restricted or prevented from sliding against the mounting face 170 when mounted thereto. In other aspects, additionally or alternatively, a friction promoting surface may be included with the handheld showerhead 102 at the coupling area to the mounting face 170.

The shoulders 196 of the bottom portion 194 are rigid, and thus, are configured to not move or deform. Rather, the shoulders 196 form a concave recess at the bottom portion 194 that is configured to capture the intersection 162 of the head 114 and the handle 116 (shown in FIG. 2) of the handheld showerhead 102. The shoulders 196 project a distance 210 that is less than the thickness 164 of the intersection 162 (shown in FIG. 3). In an aspect, the shoulders 196 project a distance 210 that is less than the thickness 164 of the intersection 162. The shoulders 196 have a curved upper and lower boundary 212, 214 so as to correspond to the curvatures of the handheld showerhead 102. A radius of curvature 216 of the shoulders 196 is less than a radius of curvature 218 of the top portion 192. The shoulders 196 are disposed above the inlet 108 of the housing 106 along the vertical direction 172.

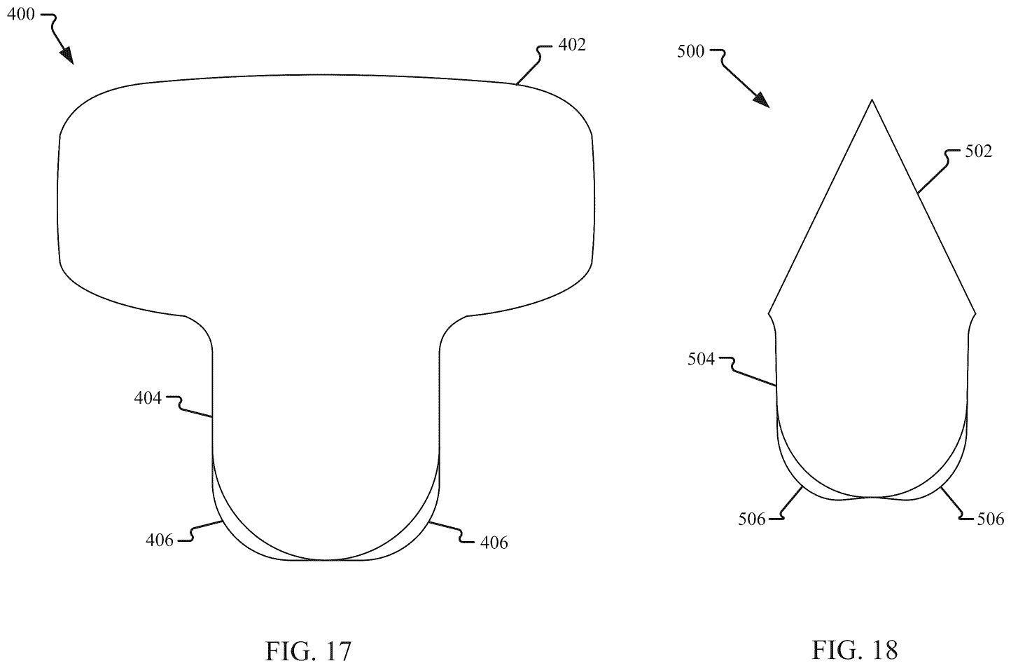

While one exemplary configuration of the geometry of the mounting face 170 is shown and described. It should be appreciated that other geometry configuration of the mounting face 170 are complemented herein. For example, the mounting face may be elongated in a horizontal direction with shoulders below. In other examples, the mounting face may be larger and capture more of the rear face of the head of the handheld showerhead. Exemplary alternative configurations of the mounting face are shown below and in reference to FIGS. 17 and 18. Similarly, the housing 106 may have any other shape and/or size as required or desired. In an aspect, the anti-rotation coupling between the handheld showerhead and the docking support may include shoulders that extend from the handheld showerhead. In this example, the shoulders on the handheld showerhead receive at least a portion of the second portion of the mounting face of the docking support so as to restrict or prevent rotation of the handheld showerhead when attached to the docking support.

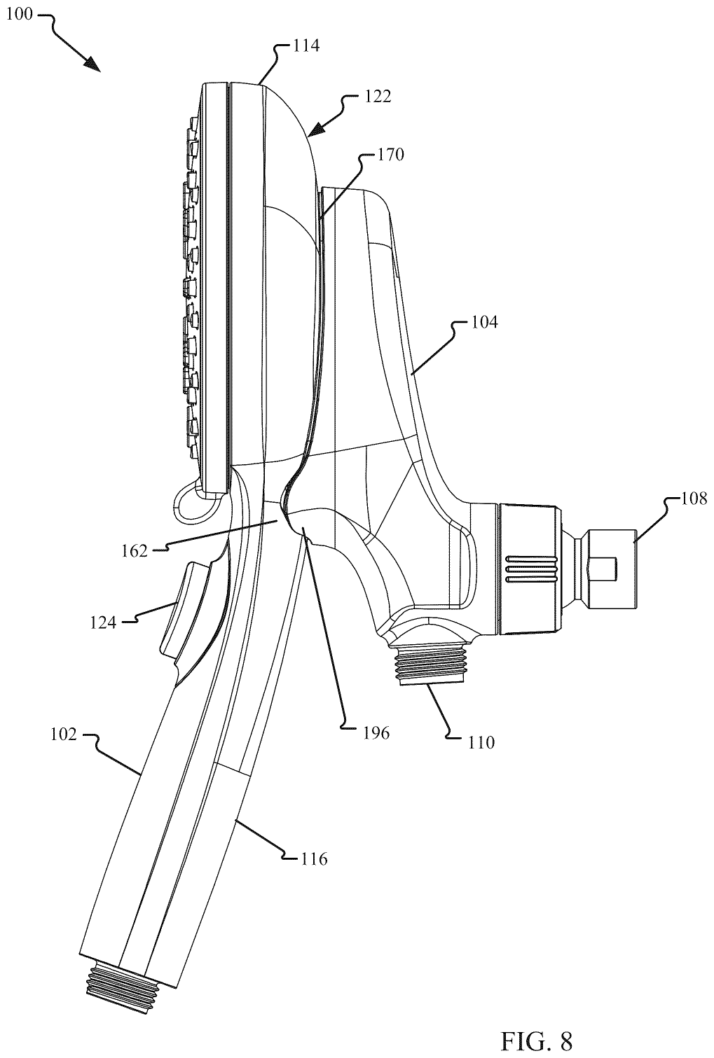

FIG. 8 is side view of the showerhead assembly 100. Certain components are described above and are not necessarily described further below. As illustrated in FIG. 8, the handheld showerhead 102 is mounted to the docking support 104 in a docked configuration. The rear face 122 of the head 114 of the handheld showerhead 102 is magnetically engaged with the mounting face 170 of the docking support 104. This magnetic connection, however, may not prevent rotation of the handheld showerhead 102 relative to the docking support 104. As such, the shoulders 196 at least partially captures a portion of intersection 162 between the head 114 and the handle 116 to restrict rotation of the handheld showerhead 102. The shoulders 196 do not prevent pulldown or pull-off of the handheld showerhead 102 from the docking support 104. For example, the shoulders 196 have a rounded outer perimeter so as to not restrict pull down and allowing the handheld showerhead 102 to be moved to an undocked configuration by merely pulling apart the magnetic connection. The shoulders 196 directly contacts the intersection 162 area of the handheld showerhead 102 when in the docked configuration.

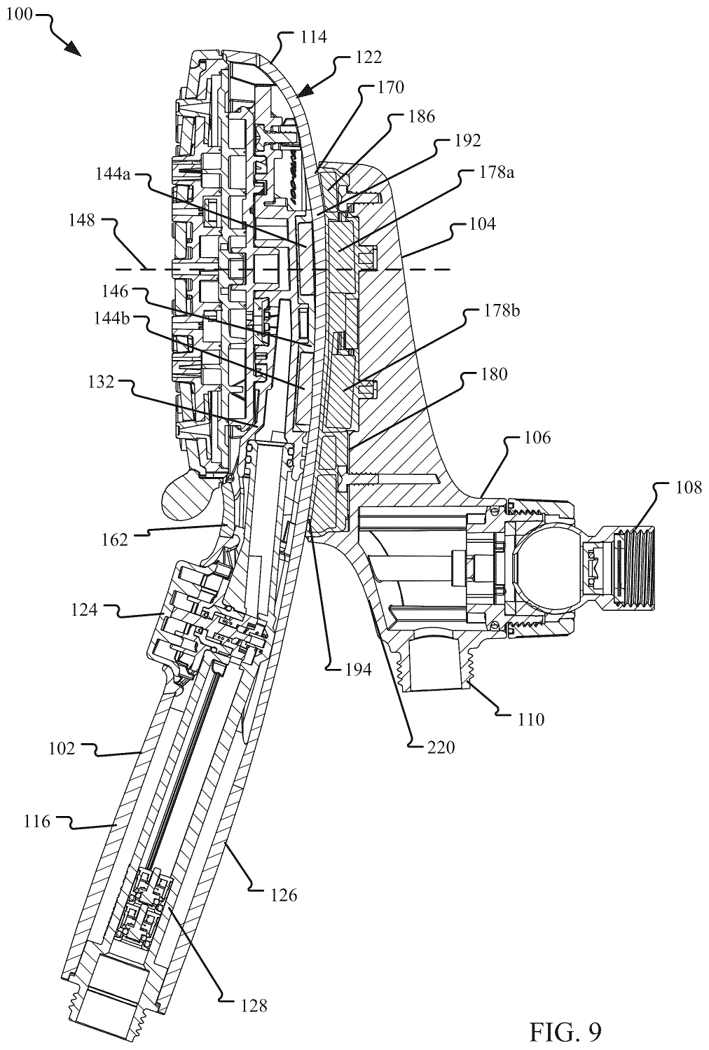

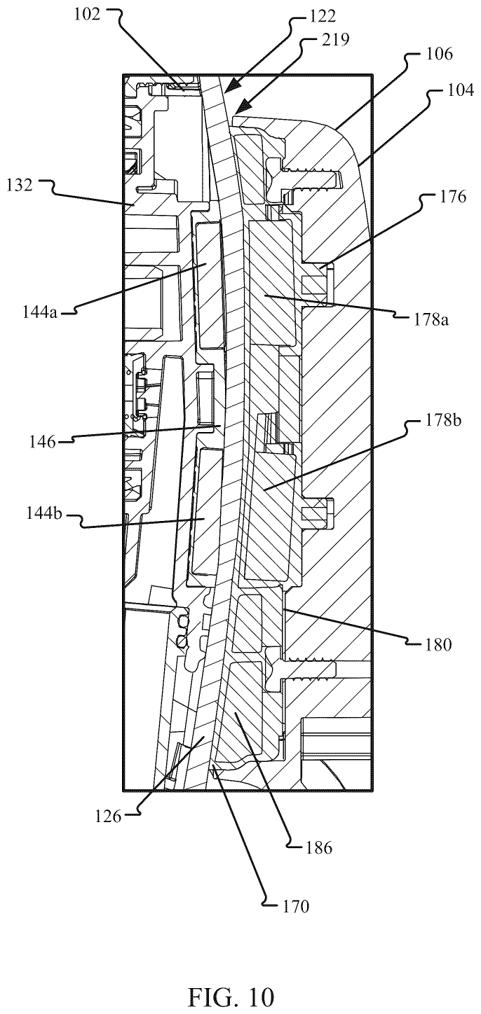

FIG. 9 is a cross-sectional view of the showerhead assembly 100. FIG. 10 in an enlarged cross-section view of a connection interface between the handheld showerhead 102 and the docking support 104. Referring concurrently to FIGS. 9 and 10, certain components are described above and are not necessarily described further below. As illustrated, the handheld showerhead 102 is mounted to the docking support 104 in a docked configuration. In the docked configuration, the magnets 144 embedded underneath the rear face 122 of the head 114 of the handheld showerhead 102 are aligned and coupled to the magnets 178 embedded underneath the mounting face 170 of the docking support 104. In the docked configuration, the horizontal centerline plane 148 of the head 114 of the handheld showerhead 102 is disposed above the inlet 108 of the docking support 104. In the example, the top magnets 144a, 178a are positioned along the centerline plane 148 with the bottom magnets 144b, 178b below. The bottom magnets 144b, 178b are disposed above the shoulders 196 (shown in FIG. 8) as described above.

The mounting face 170 of the docking support 104 is positioned directly against the housing body 126 of the handheld showerhead 102 with the magnets 144 on the opposite side. In the example, the mounting face 170 projects 219 outward from the housing 106 of the docking support 104 so that it is only the mounting face 170 contacting the handheld showerhead 102. The magnets 178 are adjacent to the mounting face 170 with the cover plate 180 disposed therebetween. This structure reduces the component layers between the magnets 144, 178 so that magnetic coupling strength can be reduced while still providing a watertight seal around the magnets 144, 178. The magnets 144, 178 are substantially cylindrical in shape, and thus, include planar surfaces that magnetically attract to each other. The rear face 122 and the mounting face 170, however, are convex/concave in shape. As such, the top magnets 144a, 178a are off plane (e.g., not on parallel planes) from the bottom magnets 144b, 178b.

Both the top portion 192 of the mounting face 170 and the bottom portion 194 of the mounting face 170 correspond to the shape of the housing body 126 of the handheld showerhead 102. As such, the location and orientation of the magnets 144, 178 embedded therein are not externally visible so as to facilitate the aesthetic characteristics of the showerhead assembly 100.

The housing 106 of the docking support 104 is recessed 220 below the shoulders 196 such that the mounting face 170 is projecting from the inlet 108 and outlet 110. The recess 220 also spaces the housing 106 away from the handle 116 of the handheld showerhead 102 below the intersection 162 so that the user can operate the actuator 124 and grasp the handle 116.

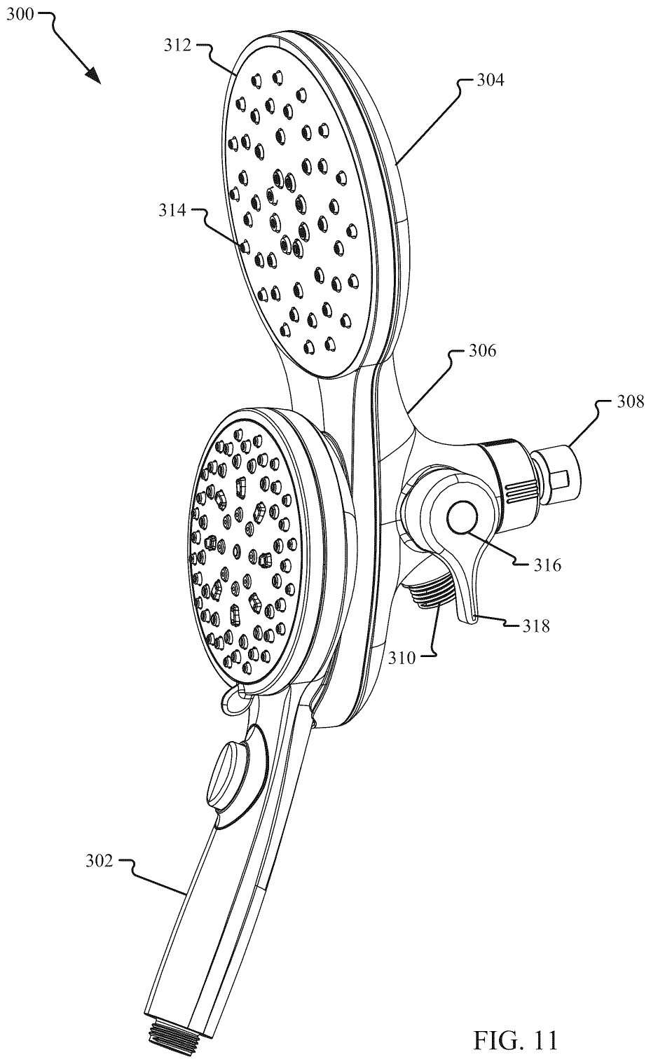

FIG. 11 is a perspective view of another showerhead assembly 300. The showerhead assembly 300 includes a handheld showerhead 302 and a docking support 304. In this example, the docking support 304 includes a housing 306 defining an inlet 308 and an outlet 310. The inlet 308 is configured to couple to a water source (e.g., a shower arm or the like) so that a flow of water is received and flows though the docking support 304. The housing 306 also supports a nozzle assembly 312 having a plurality of outlet nozzles 314 configured to discharge a flow of water from the docking support 304. The handheld showerhead 302 has the same construction as the handheld showerhead 102 and shown in FIGS. 2-4. The handheld showerhead 302 is configured to removably mount to the docking support 304 via a magnetic connection. Accordingly, in a docked configuration (shown in FIG. 11), the handheld showerhead 302 is secured to the docking support 304 so that a user may shower without needing to hold the handheld showerhead 302. In an undocked configuration, the handheld showerhead 302 is removed from the docking support 304 and is manually moved remotely relative to the docking support 304 as required or desired.

A hose (not shown) is coupled between the handheld showerhead 302 and the outlet 310 of the docking support 304 so that the handheld showerhead 302 and the docking support 304 arc coupled in fluid communication. Additionally, a valve assembly 316 is supported on the docking support 304 and configured to direct water flow to the handheld showerhead 302, the nozzle assembly 312 on the docking support 304, or both the handheld showerhead 302 and the nozzle assembly 312. The valve assembly 316 includes a lever 318 configured to rotate and switch the flow of water as required or desired.

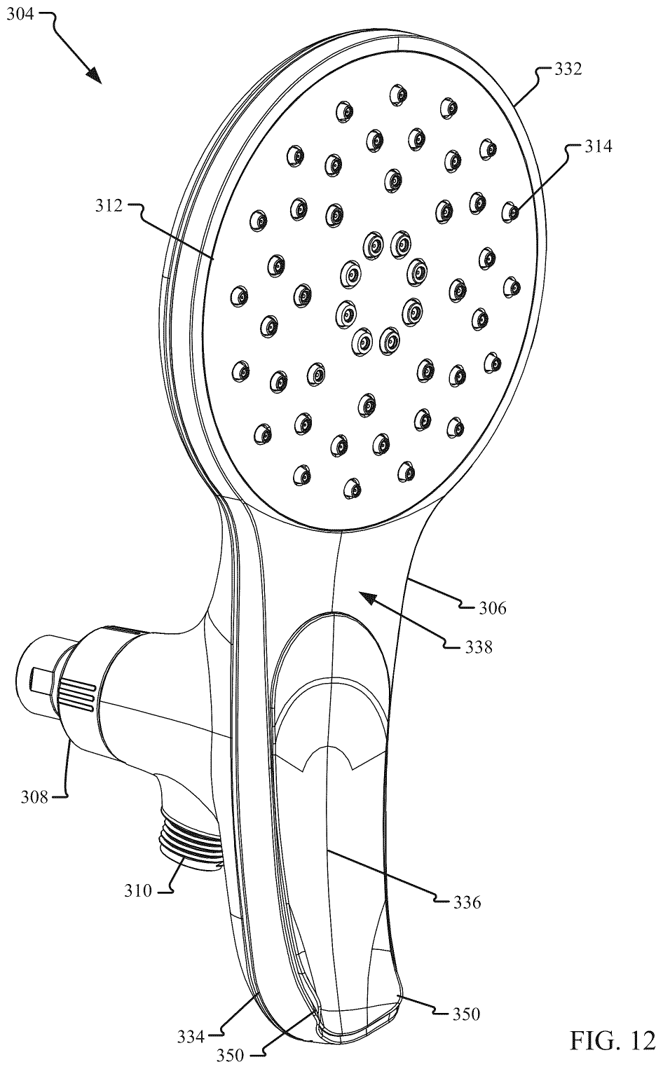

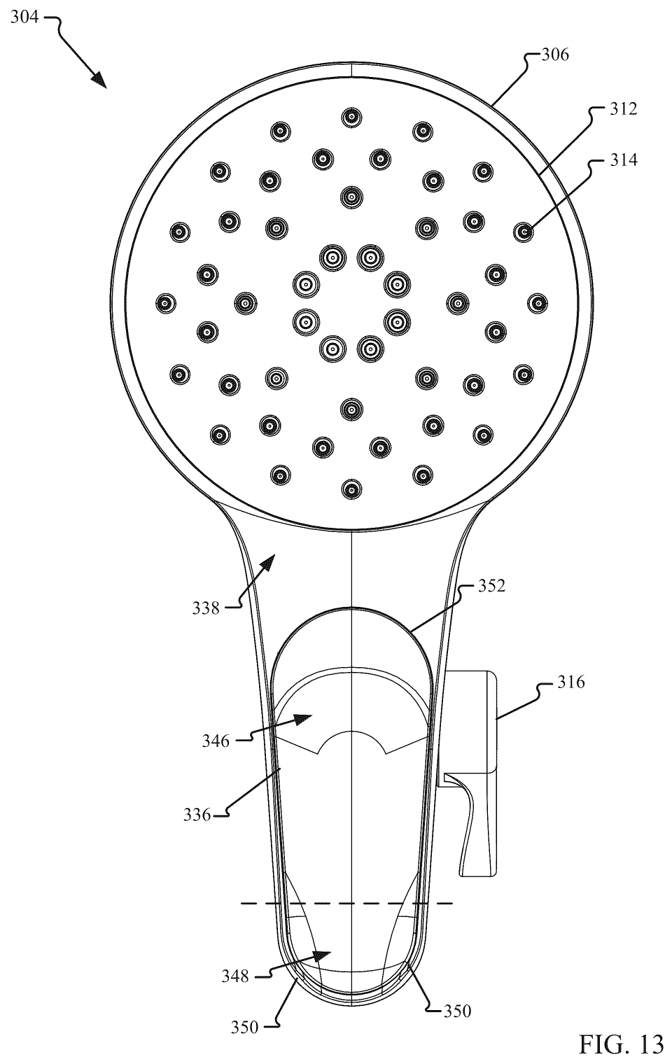

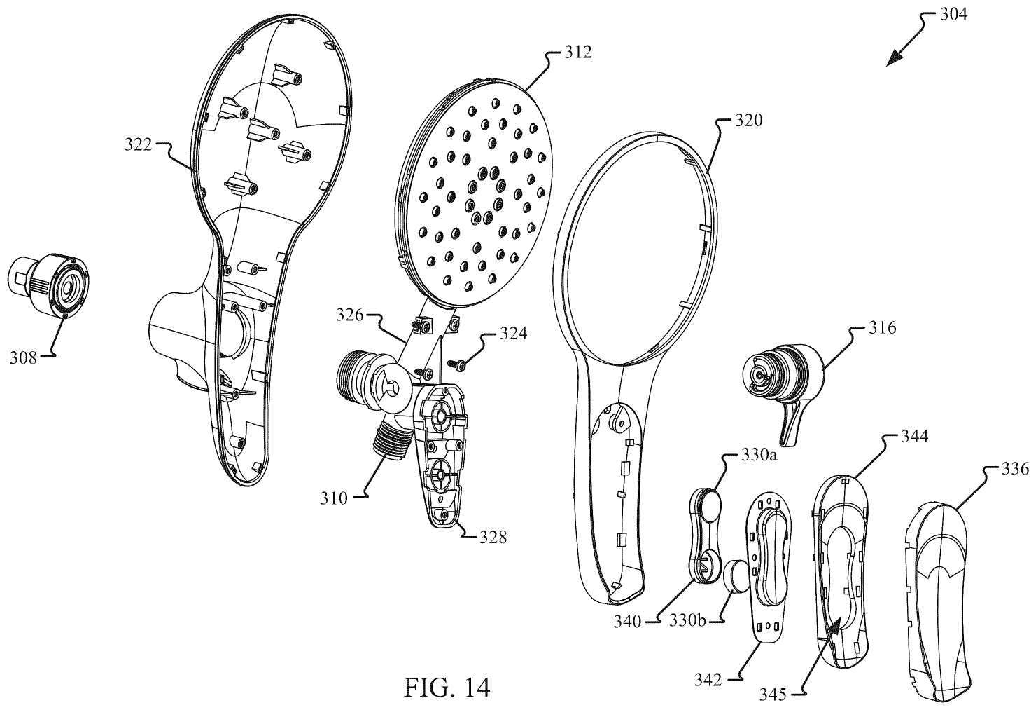

FIG. 12 is a front perspective view of the docking support 304. FIG. 13 is a front view of the docking support 304. FIG. 14 is a front exploded perspective view of the docking support 304. Referring concurrently to FIGS. 12-14, the docking support 304 includes the housing 306 defining the inlet 308 and the outlet 310. The inlet 308 is formed as a ball joint that couples to the housing 306. The inlet 308 couples to a water supply, such as a shower arm, and allows the housing 306 to be adjustably positioned relative to the inlet 308 via the ball joint. In some examples, the inlet 308 may include a quick connect assembly, such as the features described in WO2022/198060, published Sep. 22, 2022 and which is incorporated by reference herein in its entirety.

In the example, the housing 306 is a two piece housing with a front portion 320 and a rear portion 322 that are coupled together with one or more fasteners 324. A manifold assembly 326 is supported within housing 306 and defines the fluid flow paths to the nozzle assembly 312 and the outlet 310 and controlled by the valve assembly 316 also supported by the housing 306. The manifold assembly 326 also includes a bracket 328 that supports magnets 330 for mounting the handheld showerhead 302 (shown in FIG. 11) to the docking support 304.

The housing 306 includes an upper portion 332 and an opposite lower portion 334. The upper portion 332 supports the nozzle assembly 312 such that the outlet nozzles 314 face in a forward direction. The lower portion 334 supports the inlet 308 and the outlet 310. Additionally, the lower portion 334 supports a mounting face 336 that is used to couple the handheld showerhead 302 to the docking support 304. The mounting face 336 also faces in a forward direction. By positioning the mounting face 336 below the nozzle assembly 312, the docking support 304 can also be used as a showerhead. The lower portion 334 is elongated in a vertical direction and includes a front face 338 that receives the mounting face 336. The valve assembly 316 is supported on the lower portion 334.

The mounting face 336 is supported on the housing 306 with similar components to that described above. The docking support 304 includes a discrete holder 340 that couples within the front face 338 of the housing 306 and to the bracket 328 of the manifold assembly 326. The holder 340 supports a pair of magnets 330 with a top magnet 330a and a bottom magnet 330b aligned along the vertical direction. A cover plate 342 secures the magnets 330 within the holder 340. A support plate 344 couples to the cover plate 342 via a snap fit connection. The support plate 344 has an opening 345 so that the magnets 330 extends at least partially through the support plate 344 and the support plate 344 does not cover the magnets 330. The mounting face 336 couples to the support plate 344 and covers the magnets 330 and so that the magnets 330 are positioned underneath the mounting face 336.

The mounting face 336 forms at least partially the forward most component of the docking support 304 and is configured to receive the handheld showerhead 302. The mounting face 336 includes a top portion 346 and a bottom portion 348 elongated in the vertical direction. The top portion 346 has the magnets 330 disposed underneath the mounting face 336. The bottom portion 348 does not have the magnets 330 disposed underneath the mounting face 336. The bottom portion 348 includes a pair of shoulders 350 projecting therefrom. The pair of shoulders 350 are shaped and sized to at least partially receive the intersection between the head and the handle of the handheld showerhead 302. In the example, the shoulders 350 have an outer perimeter that is rounded and are substantially rigid.

In the example, the geometry of the mounting face 336 may be the same or similar to the mounting face 170 described above and for manufacturing efficiencies. In other examples, the mounting face 336 may include an upper extension 352 that may not engage with the handheld showerhead 302. The mounting face 336 a substantially smooth exterior surface for receiving the handheld showerhead 302. In this example, the mounting face 336 is only a portion of the front face 338 of the housing 306 of the docking support 304 with the nozzle assembly 312 being positioned above. The top portion 346 of the mounting face 336 does not have and is devoid of any projections, tabs, recesses, detents, or the like structural features. The bottom portion 348 of the mounting face 336 only has the shoulders 350. In the example, the exterior surface of the mounting face 336 smoothly transitions between the top and bottom portions 346, 348 and without any break in the concave shape. In an aspect, the exterior surface of the mounting face 336 is not a planar surface. In an aspect, the exterior surface of the mounting face 336 may include a friction promoting surface, such as but not limited to, rubber and the like, so that the handheld showerhead 302 is restricted or prevented from sliding against the mounting face 336 when mounted thereto. In other aspects, additionally or alternatively, a friction promoting surface may be included with the handheld showerhead 102 at the coupling area to the mounting face 336.

The shoulders 350 of the bottom portion 348 are rigid, and thus, are configured to not move or deform. Rather, the shoulders 350 form a concave recess at the bottom portion 348 that is configured to capture a portion of the handheld showerhead 302. The shoulders 350 can have a similar geometry to the shoulder 196 described above. The shoulders 350 are disposed below the inlet 308 of the housing 306 along the vertical direction and below the valve assembly 316.

While one exemplary configuration of the geometry of the mounting face 336 is shown and described. It should be appreciated that other geometry configuration of the mounting face 336 are complemented herein. For example, the mounting face may be elongated in a horizontal direction with shoulders below. In other examples, the mounting face may be larger and capture more of the rear face of the head of the handheld showerhead. Similarly, the housing 306 and nozzle assembly 312 may have any other shape and/or size as required or desired. For example, the nozzle assembly may be disposed directly adjacent to or at least partially surround the mounting face instead of spaced apart as shown.

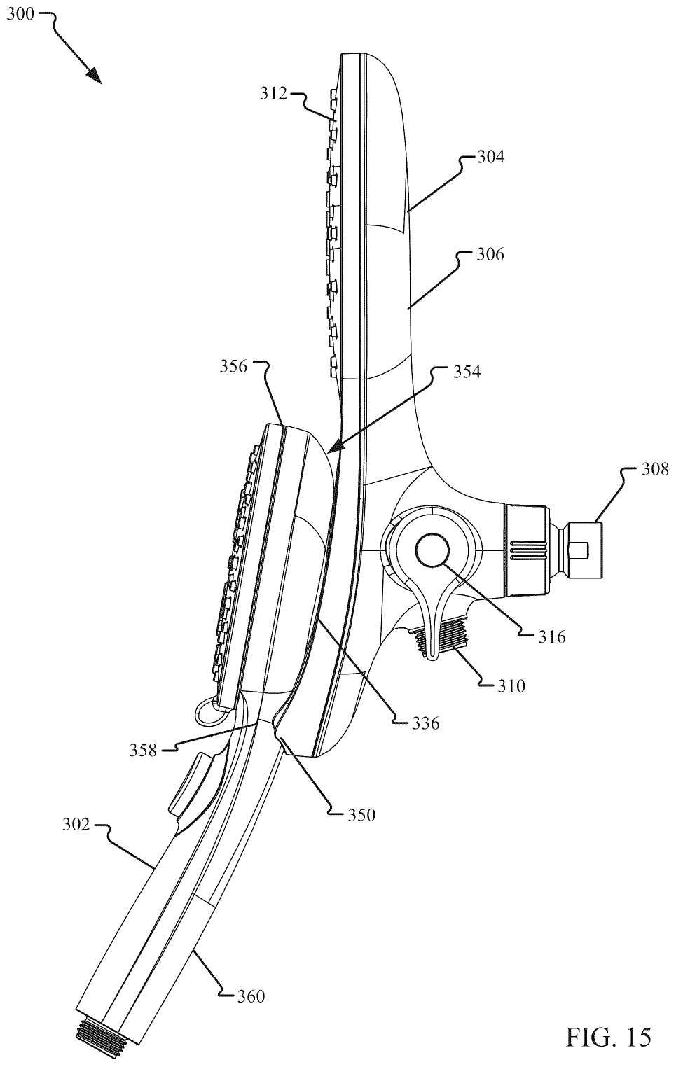

FIG. 15 is a side view of the showerhead assembly 300. Certain components are described above and are not necessarily described further below. As illustrated in FIG. 15, the handheld showerhead 302 is mounted to the docking support 304 in a docked configuration. A rear face 354 of a head 356 of the handheld showerhead 302 is magnetically engaged with the mounting face 336 of the docking support 304. This magnetic connection, however, may not prevent rotation of the handheld showerhead 302 relative to the docking support 304. As such, the shoulders 350 at least partially captures a portion of an intersection 358 between the head 356 and a handle 360 to restrict rotation of the handheld showerhead 302. The shoulders 350 do not prevent pulldown or pull-off of the handheld showerhead 302 from the docking support 304. For example, the shoulders 350 have a rounded outer perimeter so as to not restrict pull down and allowing the handheld showerhead 302 to be moved to an undocked configuration by merely pulling apart the magnetic connection. The shoulders 350 directly contacts the intersection 358 area of the handheld showerhead 302 when in the docked configuration and extend over the intersection 358 a distance that is less than half of the thickness of the intersection 358.

In the example, the nozzle assembly 312 defines a first front plane of the docking support 304. The mounting face 336 is on a second front plane of the docking support 304 and is not parallel to the nozzle assembly 312. Rather, the mounting face 336 projects in a forward direction from the nozzle assembly 312 such that the head 356 of the handheld showerhead 302 is positioned forward of the nozzle assembly 312 of the docking support 304. In an aspect, the shoulders 350 are offset in the forward direction from the nozzle assembly 312. In another aspect, the top portion 346 of the mounting face 336 is offset in the forward direction from the nozzle assembly 312.

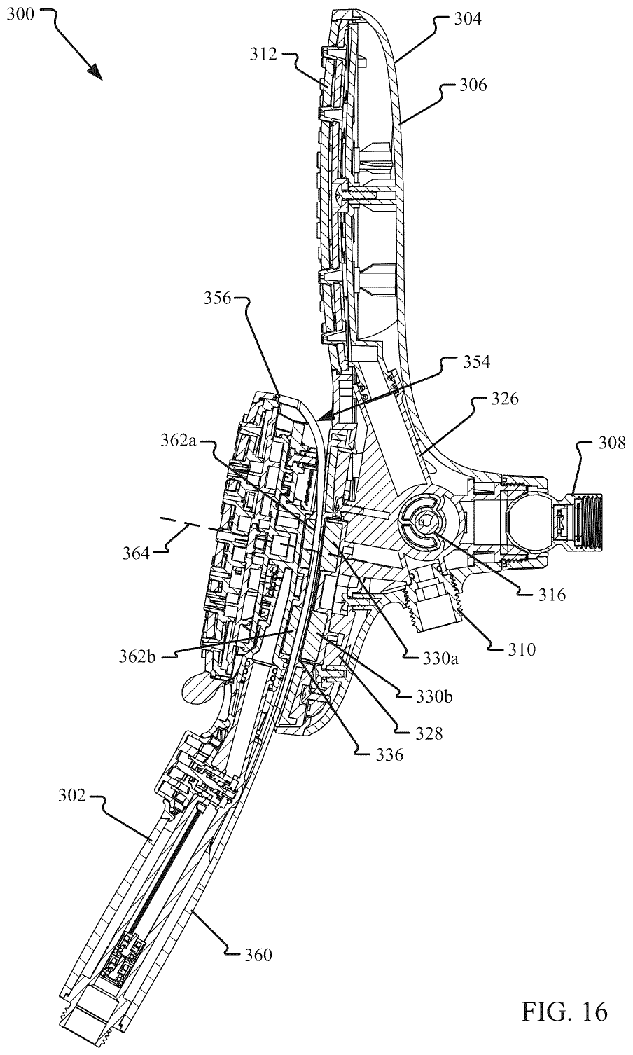

FIG. 16 is a cross-sectional view of the showerhead assembly 300. Certain components are described above and are not necessarily described further below. As illustrated, the handheld showerhead 302 is mounted to the docking support 304 in a docked configuration. In the docked configuration, magnets 362 embedded underneath the rear face 354 of the head 356 of the handheld showerhead 302 are aligned and coupled to the magnets 330 embedded underneath the mounting face 336 of the docking support 304. In the docked configuration, a horizontal centerline plane 364 of the head 356 of the handheld showerhead 302 is disposed below the inlet 308 of the docking support 304. In the example, the top magnets 330a, 362a are positioned along the centerline plane 364 with the bottom magnets 330b, 362b. The centerline plane 364 of the head 356 is also completely below the nozzle assembly 312 and is not parallel to a horizontal centerline plane of the nozzle assembly 312. The centerline plane 364 of the head 356 is also below the valve assembly 316 of the docking support 304.

As described above, the mounting face 336 projects from the housing 306 of the docking support 304 so that it is only the mounting face 336 contacting the handheld showerhead 302. The shoulders 350 (shown in FIG. 15) are the lowest most component on the docking support 304 so that the handle 360 of the handheld showerhead 302 can be grasped by the user. In the example, the mounting face 336 is spaced apart from the nozzle assembly 312. This positions the coupling components for the handheld showerhead 302 separate from the nozzle assembly 312. As such, an overall thickness of the housing 306 is thinner than if the handheld showerhead 302 is connected within the nozzle assembly 312 and aesthetics are facilitated.

FIGS. 17 and 18 are schematic views of alternative exemplary mounting faces 400, 500 for a docking support. As described above, the mounting faces 400, 500 form the forward most component of the docking support and are configured to receive the handheld showerhead. The mounting faces 400, 500 are a substantially smooth exterior surface for receiving the handheld showerhead. Starting first with the mounting face 400, the mounting face includes a top portion 402 and a bottom portion 404 adjacent to each other along a vertical direction. The top portion 402 is elongated in a horizontal direction and includes magnets disposed underneath. In an example, the magnets may be spaced in the horizontal direction. The bottom portion 404 does not include magnets and includes a pair of shoulders 406 projecting therefrom. In the example, the shoulders 406 have an outer perimeter that is rounded. In this example, a surface area of the top portion 402 is greater than a surface area of the bottom portion 404. The top portion 402 of the mounting face 400 does not have and is devoid of any projections, tabs, recesses, detents, or the like structural features. The bottom portion 404 of the mounting face 400 only has the shoulders 406. In the example, the exterior surface of the mounting face 400 smoothly transitions between the top and bottom portions 402, 404 and without any break. In an aspect, the exterior surface of the mounting face 400 is not a planar surface. The mounting face 400 is concave in shape so as to correspond to the rear face of the showerhead. In an aspect, the exterior surface of the mounting face 400 may include a friction promoting surface.

Turning next to the mounting face 500, the mounting face includes a top portion 502 and a bottom portion 504 adjacent to each other along a vertical direction. The top portion 502 is polygonal in shape and includes one or more magnets disposed underneath. The bottom portion 504 does not include magnets and includes a pair of shoulders 506 projecting therefrom. In the example, the shoulders 506 have an outer perimeter that is rounded. The top portion 502 of the mounting face 500 does not have and is devoid of any projections, tabs, recesses, detents, or the like structural features. The bottom portion 504 of the mounting face 500 only has the shoulders 506. In the example, the exterior surface of the mounting face 500 smoothly transitions between the top and bottom portions 502, 504 and without any break. In an aspect, the exterior surface of the mounting face 500 is not a planar surface. The mounting face 500 is concave in shape so as to correspond to the rear face of the showerhead. In an aspect, the exterior surface of the mounting face 500 may include a friction promoting surface.

The showerhead assemblies described above provide a magnetic mount for a handheld showerhead without any external structures added to the handheld showerhead. This is not only aesthetically pleasing, but also increases end user experience as there are no exterior projections or recesses on the handheld showerhead that can catch on objects within the shower during use. The docking support has a mounting face that is easily accessible to the user and is wide open so that the handheld showerhead can be easily mounted thereto. The mounting face facilitates the handheld showerhead from both being pulled outwards to disconnect from the docking support and being pulled downwards to disconnect from the docking support as the handheld showerhead is often mounted above a user's head. Additionally, the mounting face includes a pair of shoulders that are configured to capture a portion of a handle of the handheld showerhead so that rotation of the handheld showerhead when mounted to the docking support is restricted or prevented. However, the shoulders do not restrict the pulldown or pullout disconnect motion for the user.

The mounting face forms a top portion that houses the magnets, while a bottom portion forms the shoulders and does not include magnets. The mounting face is concave so as to receive the exterior convex rear face surface of the handheld showerhead. There are upper and lower magnets that connect to corresponding magnets within the head of the handheld showerhead. The magnets within the head are disposed at or below a horizontal centerline plane so that when the handheld showerhead is mounted to the mounting face, the head is positioned higher in the shower. Additionally, the shoulders at least partially capture the interface between the head and the handle of the handheld showerhead so as to restrict rotation. The shoulders are substantially rigid and rounded so that the handheld showerhead can be pulled downwards to disconnect.

In examples, the docking support can include its own nozzle assembly for showering. The mounting face is spaced apart from the nozzle assembly on the docking support so that the handheld showerhead can be used with the nozzle assembly while the docking support maintains a slim profile.

Non-exclusive and non-limiting illustrative examples of the showerhead assemblies disclosed herein are provided below. An example of a showerhead assembly may include any one or more, and any combination of, the examples described below.

Example 1. A showerhead assembly including: a handheld showerhead including: a head with a front face including one or more outlet nozzles and an opposite rear face, the rear face having a substantially smooth surface, wherein one or more first magnets are disposed within the head and underneath the rear face; and a handle extending from the head; a docking support including: a housing defining an inlet and an outlet, the inlet configured to couple to a water supply, the housing defining a mounting face, the mounting face having a top portion and an opposite bottom portion, the mounting face elongated in a direction between the top portion and the bottom portion; one or more second magnets disposed within the housing and underneath the mounting face; and at least one rigid shoulder projecting from the bottom portion of the mounting face, wherein the rear face of the handheld showerhead removably mounts to the mounting face of the housing via a magnetic connection between the one or more first magnets and the one or more second magnets, and wherein when the handheld showerhead is mounted to the docking support, the at least one rigid shoulder at least partially captures a portion of the handle proximate the head to restrict rotation of the handheld showerhead relative to the docking support; and a hose coupled between the handle of the handheld showerhead and the outlet of the housing such that the handheld showerhead and the docking support are in fluid communication.

Example 2. The showerhead assembly of any one of examples 1-20, wherein the mounting face has a substantially smooth surface.

Example 3. The showerhead assembly of any one of examples 1-20, wherein the mounting face has a vertical height between the top portion and the bottom portion and a transverse width orthogonal to the vertical height, the vertical height greater than the transverse width, and wherein the vertical height is more than half of a height of the head of the handheld showerhead.

Example 4. The showerhead assembly of any one of examples 1-20, wherein the vertical height is at least 75% of the height of the head of the handheld showerhead.

Example 5. The showerhead assembly of any one of examples 1-20, wherein the transverse width is less than a width of the head of the handheld showerhead.

Example 6. The showerhead assembly of any one of examples 1-20, wherein the handle has a thickness, the at least one rigid shoulder projecting less than half of the thickness of the handle.

Example 7. The showerhead assembly of any one of examples 1-20, wherein the at least one rigid shoulder has curved upper and lower boundaries.

Example 8. The showerhead assembly of any one of examples 1-20, wherein the at least one rigid shoulder does not prevent pulldown of the handheld showerhead from the docking support.

Example 9. The showerhead assembly of any one of examples 1-20, wherein the one or more first magnets are off-center in the head.

Example 10. The showerhead assembly of any one of examples 1-20, wherein the docking support further includes one or more second outlet nozzles.

Example 11. A showerhead assembly including: a handheld showerhead including: a housing body defining a head and a handle extending from the head, the housing body having an exterior surface, wherein the exterior surface of a rear of the head has a convex curvature and is devoid of any projecting or recessed structure; one or more outlet nozzles supported by the housing body at a front of the head; and a pair of first magnets disposed within the housing body at the rear of the head, the pair of first magnets aligned with an extension direction of the handle; a docking support including: a housing defining an inlet and an outlet, the inlet configured to couple to a water supply, the housing having a front face including a mounting face, the mounting face having a substantially smooth surface that corresponds in shape to the exterior surface of the rear of the head of the housing body, the mounting face including a pair of lower shoulders that correspond in shape to an intersection of the handle at the head; a pair of second magnets disposed within the housing and underneath the mounting face, the pair of second magnets offset from the pair of lower shoulders, wherein the head of the housing body removably mounts to the mounting face of the housing via a magnetic connection between the pair of first magnets and the pair of second magnets, and wherein when the handheld showerhead is mounted to the docking support, the pair of lower shoulders at least partially captures the intersection of the handle at the head; and a hose coupled between the handle of the handheld showerhead and the outlet of the housing such that the handheld showerhead and the docking support are in fluid communication.

Example 12. The showerhead assembly of any one of examples 1-20, wherein the pair of lower shoulders restrict rotation of the handheld showerhead and allow the handheld showerhead to be pulled downward relative to the docking support.

Example 13. The showerhead assembly of any one of examples 1-20, wherein the mounting face is elongated in a vertical direction, the mounting face having a height that is less than a height of the head of the housing body.

Example 14. The showerhead assembly of any one of examples 1-20, wherein the mounting face is the entire front face of the housing.

Example 15. The showerhead assembly of any one of examples 1-20, wherein the docking support includes one or more second outlet nozzles supported at the front face of the housing.

Example 16. A showerhead assembly including: a docking support including: a housing defining an inlet and an outlet, the inlet configured to couple to a water supply, the housing including a mounting face having a first portion and an adjacent second portion, the mounting face elongated in a direction between the first portion and the second portion, the first portion having a substantially smooth concave exterior surface; and one or more first magnets mounted below the exterior surface of the first portion; a handheld showerhead including: a head with a front face defining one or more outlet nozzles and an opposite rear face, wherein one or more second magnets are disposed within the head and underneath the rear face; and a handle extending from the head; an anti-rotation coupling including a pair of rounded shoulders; and a hose coupled between the handle of the handheld showerhead and the outlet of the housing such that the handheld showerhead and the docking support are in fluid communication, wherein the handheld showerhead removably mounts to the docking support via a magnetic connection between the rear face of the handheld showerhead and the first portion of the mounting face, wherein the pair of rounded shoulders are configured to extend between at least a portion of the handheld showerhead and the second portion of the mounting face to restrict rotation of the handheld showerhead relative to the docking support, and wherein the pair of rounded shoulders allow the handheld showerhead to be pulled downwards to detach the handheld showerhead from the docking support.

Example 17. The showerhead assembly of any one of examples 1-20, wherein the pair of rounded shoulders are integrated within the second portion of the mounting, and wherein the pair of rounded shoulders are rigid and directly contact an intersection of the handle and the head of the handheld showerhead when the handheld showerhead is mounted to the docking support.

Example 18. The showerhead assembly of any one of examples 1-20, wherein at least a portion of the mounting face includes an exterior rubber layer.

Example 19. The showerhead assembly of any one of examples 1-20, wherein the substantially smooth concave exterior surface of the first portion extends within the second portion of the mounting face.

Example 20. The showerhead assembly of any one of examples 1-20, wherein the docking support includes a plurality of outlet nozzles spaced apart from the mounting face.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about” shall mean plus or minus ten percent.

Throughout this description, references to orientation (e.g., front (ward), rear (ward), top, bottom, back, right, left, upper, lower, etc.) of the components of the showerhead assembly relate to their position when installed on water source and are used for ease of description and illustration only. No restriction is intended by use of the terms regardless of how the components of the showerhead assembly are situated on its own.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed is:

1. A showerhead assembly comprising:
a handheld showerhead including:
a head with a front face including one or more outlet nozzles and an opposite rear face, the rear face having a substantially smooth surface, wherein one or more first magnets are disposed within the head and underneath the rear face; and
a handle extending from the head;
a docking support including:
a housing defining an inlet and an outlet, the inlet configured to couple to a water supply, the housing defining a mounting face, the mounting face having a top portion and an opposite bottom portion, the mounting face elongated in a direction between the top portion and the bottom portion;
one or more second magnets disposed within the housing and underneath the mounting face; and
at least one rigid shoulder projecting from the bottom portion of the mounting face, wherein the rear face of the handheld showerhead removably mounts to the mounting face of the housing via a magnetic connection between the one or more first magnets and the one or more second magnets, and wherein when the handheld showerhead is mounted to the docking support, the at least one rigid shoulder at least partially captures a portion of the handle proximate the head to restrict rotation of the handheld showerhead relative to the docking support; and
a hose coupled between the handle of the handheld showerhead and the outlet of the housing such that the handheld showerhead and the docking support are in fluid communication.

2. The showerhead assembly of claim 1, wherein the mounting face has a substantially smooth surface.

3. The showerhead assembly of claim 1, wherein the mounting face has a vertical height between the top portion and the bottom portion and a transverse width orthogonal to the vertical height, the vertical height greater than the transverse width, and wherein the vertical height is more than half of a height of the head of the handheld showerhead.

4. The showerhead assembly of claim 3, wherein the vertical height is at least 75% of the height of the head of the handheld showerhead.

5. The showerhead assembly of claim 3, wherein the transverse width is less than a width of the head of the handheld showerhead.

6. The showerhead assembly of claim 1, wherein the handle has a thickness, the at least one rigid shoulder projecting less than half of the thickness of the handle.

7. The showerhead assembly of claim 1, wherein the at least one rigid shoulder has curved upper and lower boundaries.

8. The showerhead assembly of claim 1, wherein the at least one rigid shoulder does not prevent pulldown of the handheld showerhead from the docking support.

9. The showerhead assembly of claim 1, wherein the one or more first magnets are off-center in the head.

10. The showerhead assembly of claim 1, wherein the docking support further includes one or more second outlet nozzles.

11. A showerhead assembly comprising:
a handheld showerhead including:
a housing body defining a head and a handle extending from the head, the housing body having an exterior surface, wherein the exterior surface of a rear of the head has a convex curvature and is devoid of any projecting or recessed structure;
one or more outlet nozzles supported by the housing body at a front of the head; and
a pair of first magnets disposed within the housing body at the rear of the head, the pair of first magnets aligned with an extension direction of the handle;
a docking support including:
a housing defining an inlet and an outlet, the inlet configured to couple to a water supply, the housing having a front face including a mounting face, the mounting face having a substantially smooth surface that corresponds in shape to the exterior surface of the rear of the head of the housing body, the mounting face including a pair of lower shoulders that correspond in shape to an intersection of the handle at the head;
a pair of second magnets disposed within the housing and underneath the mounting face, the pair of second magnets offset from the pair of lower shoulders, wherein the head of the housing body removably mounts to the mounting face of the housing via a magnetic connection between the pair of first magnets and the pair of second magnets, and wherein when the handheld showerhead is mounted to the docking support, the pair of lower shoulders at least partially captures the intersection of the handle at the head; and
a hose coupled between the handle of the handheld showerhead and the outlet of the housing such that the handheld showerhead and the docking support are in fluid communication.

12. The showerhead assembly of claim 11, wherein the pair of lower shoulders restrict rotation of the handheld showerhead and allow the handheld showerhead to be pulled downward relative to the docking support.

13. The showerhead assembly of claim 11, wherein the mounting face is elongated in a vertical direction, the mounting face having a height that is less than a height of the head of the housing body.

14. The showerhead assembly of claim 11, wherein the mounting face is the entire front face of the housing.

15. The showerhead assembly of claim 11, wherein the docking support includes one or more second outlet nozzles supported at the front face of the housing.

16. A showerhead assembly comprising:
a docking support including:
a housing defining an inlet and an outlet, the inlet configured to couple to a water supply, the housing including a mounting face having a first portion and an adjacent second portion, the mounting face elongated in a direction between the first portion and the second portion, the first portion having a substantially smooth concave exterior surface; and
one or more first magnets mounted below the exterior surface of the first portion;
a handheld showerhead including:
a head with a front face defining one or more outlet nozzles and an opposite rear face, wherein one or more second magnets are disposed within the head and underneath the rear face; and
a handle extending from the head;
an anti-rotation coupling including a pair of rounded shoulders; and
a hose coupled between the handle of the handheld showerhead and the outlet of the housing such that the handheld showerhead and the docking support are in fluid communication, wherein the handheld showerhead removably mounts to the docking support via a magnetic connection between the rear face of the handheld showerhead and the first portion of the mounting face, wherein the pair of rounded shoulders are configured to extend between at least a portion of the handheld showerhead and the second portion of the mounting face to restrict rotation of the handheld showerhead relative to the docking support, and wherein the pair of rounded shoulders allow the handheld showerhead to be pulled downwards to detach the handheld showerhead from the docking support.

17. The showerhead assembly of claim 16, wherein the pair of rounded shoulders are integrated within the second portion of the mounting, and wherein the pair of rounded shoulders are rigid and directly contact an intersection of the handle and the head of the handheld showerhead when the handheld showerhead is mounted to the docking support.

18. The showerhead assembly of claim 16, wherein at least a portion of the mounting face includes an exterior rubber layer.

19. The showerhead assembly of claim 16, wherein the substantially smooth concave exterior surface of the first portion extends within the second portion of the mounting face.

20. The showerhead assembly of claim 16, wherein the docking support includes a plurality of outlet nozzles spaced apart from the mounting face.
